(19) United States
(12) Patent Application Publication
(10) Pub. No.: US 2020/0182445 A1
(43) Pub. Date: Jun. 11, 2020

(54) OPTICAL MOUNT AND HEAT SEPARATOR APPARATUS

(71) Applicants: Richard Redpath, Cary, NC (US); James Redpath, Cary, NC (US)

(72) Inventors: Richard Redpath, Cary, NC (US); James Redpath, Cary, NC (US)

(21) Appl. No.: 16/210,176

(22) Filed: Dec. 5, 2018

(51) Int. Cl. F21V 29/502

(52) U.S. Cl. CPC F21V 29/502; F21Y 2115/30

(57) ABSTRACT

The invention provides an apparatus for dissipating heat produced by a laser beam on co-located optics for lighting projection. The apparatus is designed to mount a laser module with a collar system for laser beam alignment to provide a mounting area for lighting optics to enable dissipation of heat from the optic at a good distance away from the laser module as a plugin in lamp system.

### FIELD OF THE INVENTION

The invention relates to a laser light projection and beam channel protector apparatus suitable to dissipate heat for the optics or optomechanics as a self-container component, which laser light projection comprises a laser module usage and at least one optical element or optomechanical element for creating light projection.

### BACKGROUND OF THE INVENTION

This invention relates generally to an apparatus for the removal of heat from the impact of a laser beam on optics for lighting and beam channel protector. Particularly, this invention relates to an apparatus that is used to dissipate heat from an optic at a distance from a laser diode lighting projection module that can simply be attached onto the laser module assuring beam alignment, beam protecting, as well as distancing heat dissipation for the optic to deliver a device for providing light projection.

In prior art, laser beam impact of mounted optics can quickly be found in optical tables, vibration isolation tables for holography/interferometry, and typically honeycomb breadboards with the optics at a distance using a variety of optomechanical components. Clearly these off the shelf optomechanical components can be obtained but do not provide a means to mount to a laser module manufactured component with alignment of the laser beam and beam protection for lighting projection.

In this respect, the optical mount and heat separator apparatus substantially departs from the conventional design of prior art and in doing so provides a means to align and mount an optic to a laser module for laser beam protection and impact of the optic at a distance with a facet plane for lighting projection for unique greater potential of a self-contained lamp system.

### SUMMARY OF THE INVENTION

It is an object of the invention to provide a means for mounting optical and optomechanical components aligned to a laser beam producing source that can be heat dissipated at a distance and protect the laser beam use for lighting projection as a lamp component.

Furthermore, another object of the invention is to provide a design in which the tubular length of the apparatus can vary in length as to fit into prior art lighting fixtures such as horticulture, emergency lighting, and boat fixtures.

### BRIEF DESCRIPTION OF THE DRAWINGS

The optical mount and heat separator apparatus according to the invention will further be explained with reference to the drawing, wherein,

FIG. 1 is a perspective view of the apparatus and a cross section of individual components.

### DETAIL DESCRIPTIONS OF THE INVENTION

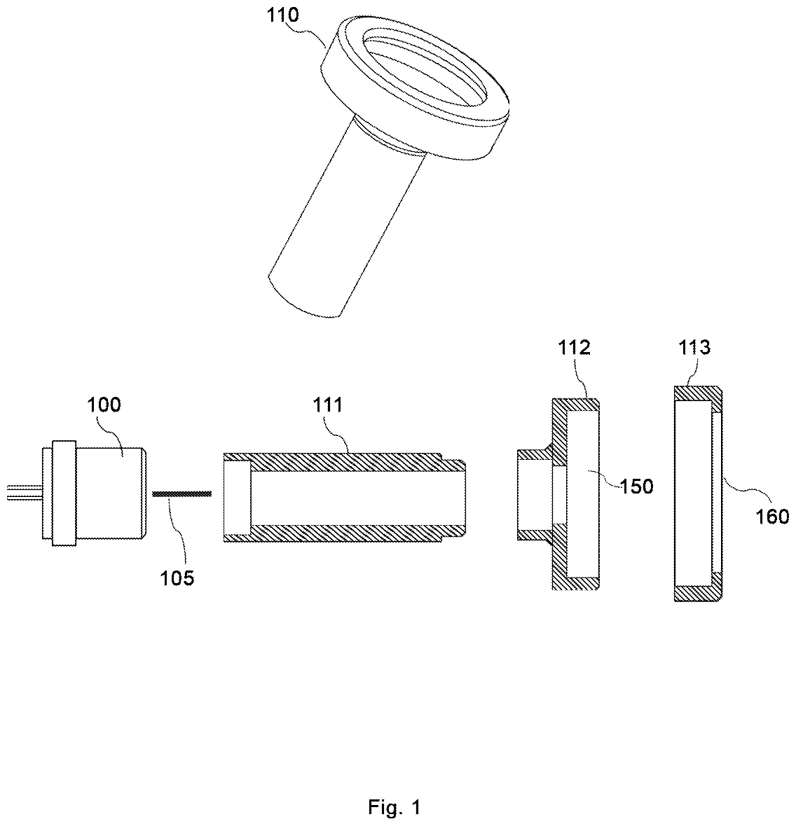

Referring to FIG. 1 at 110 is a perspective view of the apparatus which is constructed of three parts shown as cross sections at 111, 112, and 113. At 150 optical and optomechanical components can be placed and secured with cap at 113. At 100 is a laser module that can have the apparatus at 110 to collar the laser beam at 105 to traverse through tubular length 111 to optics and optomechanical components at 150 to produce lighting projection at 160. Parts of the apparatus at 112 and 113 are used to dissipate heat from optical and optomechanical components at 150.

What is claimed is:

1. Optical mount and heat separator apparatus comprising the use of a laser module collar tube section to a table mounting section for optical and optomechanical components to be contained for heat dissipation with a cap section to secure said components.

2. Optical mount and heat separator apparatus of claim 1,
the tubular collar provides a means for a laser module to be secured for laser beam travel, enclosed safety protection, and alignment to the table mounting area of optical and optomechanical components.

3. Optical mount and heat separator apparatus of claim 1
the tubular collar section is replaceable for varying lengths to fit into prior art lighting fixtures.

4. Optical mount and heat separator apparatus of claim 1,
where the collar tube section and table mount section can be manufactured as one piece.
